(19) United States
(12) Patent Application Publication
(10) Pub. No.: US 2024/0326724 A1
(43) Pub. Date: Oct. 3, 2024

(54) MOBILE OBJECT SETTING SYSTEM, MOBILE OBJECT SETTING METHOD, AND STORAGE MEDIUM

(71) Applicant: HONDA MOTOR CO., LTD., Tokyo (JP)

(72) Inventors: Yoshihiro Matsugi, Tokyo (JP); Naoki Shibata, Tokyo (JP); Shogo Usui, Tokyo (JP); Koji Hashimoto, Tokyo (JP); Shohei Kamochi, Tokyo (JP)

(21) Appl. No.: 18/588,063

(22) Filed: Feb. 27, 2024

(30) Foreign Application Priority Data
Mar. 29, 2023 (JP) 2023-052757

(51) Int. Cl. B60R 16/023

(52) U.S. Cl. CPC B60R 16/023

(57) ABSTRACT

A mobile object setting system includes a setting device configured to perform a process of setting equipment provided in a mobile object and a plurality of terminal devices capable of communicating with the setting device. The setting device includes a storage device configured to store a program and setting information of the equipment and a hardware processor. The hardware processor manages the setting information in association with a user of the mobile object by executing the program stored in the storage device, identifies the user of the mobile object based on a result of communicating with the plurality of terminal devices, and acquires the setting information of the equipment associated with the identified user from the storage device to perform the process of setting the equipment based on the acquired setting information. The plurality of terminal devices instruct the setting device to change the setting of the equipment by transmitting the terminal information stored therein to the setting device. The storage device can store a plurality of setting information items for each piece of the equipment when the number of users registered in the setting device is one.

### CROSS-REFERENCE TO RELATED APPLICATION

Priority is claimed on Japanese Patent Application No. 2023-052757, filed Mar. 29, 2023, the content of which is incorporated herein by reference.

### BACKGROUND

### Field of the Invention

The present invention relates to a mobile object setting system, a mobile object setting method, and a storage medium.

### Description of Related Art

Conventionally, a so-called smart entry function in which a vehicle door can be locked and unlocked without taking out a portable device such as an electronic key by performing a comparison process for a key ID (portable device unique information), which is unique information for each portable device, is known. In relation to the smart entry function, technology for transmitting personal information stored in a user's electronic key to a vehicle-side device through wireless communication, reading setting information associated with the personal information received by the vehicle-side device, and automatically adjusting the vehicle's driving environment (a seat position or the like) based on the setting information has been proposed (Japanese Unexamined Patent Application, First Publication No. 2010-214972). In some conventional smart entry functions, different setting information can be associated with a plurality of electronic keys. In recent years, as technology for automatically adjusting the vehicle's driving environment, technology for performing user management with an in-vehicle device connected to a vehicle electronic control unit (ECU) and automatically adjusting the driving environment based on setting information of a logged-in user has also been developed. In this case, the user can flexibly change the setting content of the driving environment by changing the logged-in user, so that the convenience of the vehicle is improved.

### SUMMARY

However, when an automatic adjustment function of an in-vehicle device is used, the user needs to manipulate an operating system of the in-vehicle device and perform a user registration task. Therefore, the automatic adjustment function of the in-vehicle device may deteriorate the usability of users who are satisfied with the setting of the driving environment associated with the conventional electronic key or users who find it troublesome to manipulate the in-vehicle device.

The present invention has been made in consideration of such circumstances and an objective of the present invention is to provide a mobile object setting system, a mobile object setting method, and a storage medium capable of improving manipulability related to automatic adjustment in relation to a vehicle control system that automatically adjusts a driving environment of a vehicle in conjunction with an in-vehicle device having a user management function. In the end, it will further improve traffic safety and contribute to the development of a sustainable transportation system.

(1): According to an aspect of the present invention, there is provided a mobile object setting system including a setting device configured to perform a process of setting equipment provided in a mobile object and a plurality of terminal devices capable of communicating with the setting device, wherein the setting device includes a storage device configured to store a program and setting information of the equipment and a hardware processor, wherein the hardware processor manages the setting information in association with a user of the mobile object by executing the program stored in the storage device, identifies the user of the mobile object based on a result of communicating with the plurality of terminal devices, and acquires the setting information of the equipment associated with the identified user from the storage device to perform the process of setting the equipment based on the acquired setting information, wherein the plurality of terminal devices instruct the setting device to change the setting of the equipment by transmitting the terminal information stored therein to the setting device, and wherein the storage device can store a plurality of setting information items for each piece of the equipment when the number of users registered in the setting device is one.

(2): In the above-described aspect (1), the plurality of terminal devices include a first terminal device and a second terminal device, and, when the number of users registered in the setting device is one and first setting information and second setting information are stored as the setting information of the equipment in the storage device, the hardware processor manages the first setting information in association with the first terminal device and manages the second setting information in association with the second terminal device.

(3): In the above-described aspect (1) or (2), a first user ID and a second user ID are registered for one user in the setting device, and the first user ID is associated with the first terminal device and the second user ID is associated with the second terminal device.

(4): In any one of the above-described aspects (1) to (3), the plurality of terminal devices include a first terminal device and a second terminal device, a first user and a second user are registered in the setting device, and, when first setting information and second setting information are stored as the setting information of the equipment in the storage device, the hardware processor manages the first setting information in association with the first terminal device and manages the second setting information in association with the second terminal device.

(5): In the above-described aspect (4), a third user is further registered in the setting device, and, when the third user is selected in the setting device after the setting device acquires the first terminal information from the first terminal device or the second terminal device, a terminal device, which has transmitted the first terminal information to the setting device, replaces the first terminal information stored in the terminal device with second terminal information stored in association with the third user in the setting device.

(6): According to an aspect of the present invention, there is provided a mobile object setting method for use in a mobile object setting system including a setting device configured to perform a process of setting equipment provided in a mobile object and a plurality of terminal devices capable of communicating with the setting device, the mobile object setting method including: managing, by the setting device, setting information of the equipment in association with a user of the mobile object; identifying, by the setting device, the user of the mobile object based on a result of communicating with the plurality of terminal devices; performing, by the setting device, a process of setting the equipment based on the setting information of the equipment associated with the identified user; and instructing, by the plurality of terminal devices, the setting device to change the setting of the equipment by transmitting the terminal information stored therein to the setting device, wherein, when the number of users registered in the setting device is one, the setting device can store a plurality of setting information items for each piece of the equipment.

(7): According to an aspect of the present invention, there is provided a storage medium storing a program for use in a mobile object setting system including a setting device configured to perform a process of setting equipment provided in a mobile object and a plurality of terminal devices capable of communicating with the setting device and configured to instruct the setting device to change the setting of the equipment by transmitting the terminal information stored therein to the setting device, wherein the program causes the setting device to: manage setting information of the equipment in association with a user of the mobile object, identify the user of the mobile object based on a result of communicating with the plurality of terminal devices, perform a process of setting the equipment based on the setting information of the equipment associated with the identified user, and manage a plurality of setting information items for each piece of the equipment when the number of users registered in the setting device is one.

According to (1) to (7), it is possible to improve manipulability related to automatic adjustment in relation to a vehicle control system that automatically adjusts a driving environment of a vehicle in conjunction with an in-vehicle device having a user management function.

### BRIEF DESCRIPTION OF THE DRAWINGS

FIG. 1 is a diagram showing an example of a configuration of a vehicle control system 1 of an embodiment.

FIG. 2 is a figure showing an example of content of account management information 92.

FIG. 3 is a flowchart showing a flow of a process executed by a controller 70.

FIG. 4 is a diagram (Part 1) showing an example of an operation of the vehicle control system 1 of the embodiment.

FIG. 5 is a diagram (Part 2) showing an example of an operation of the vehicle control system 1 of the embodiment.

### DESCRIPTION OF EMBODIMENTS

Hereinafter, embodiments of a mobile object setting system, a mobile object setting method, and a storage medium of the present invention will be described with reference to the drawings.

### [1. Overall Configuration of Vehicle Control System]

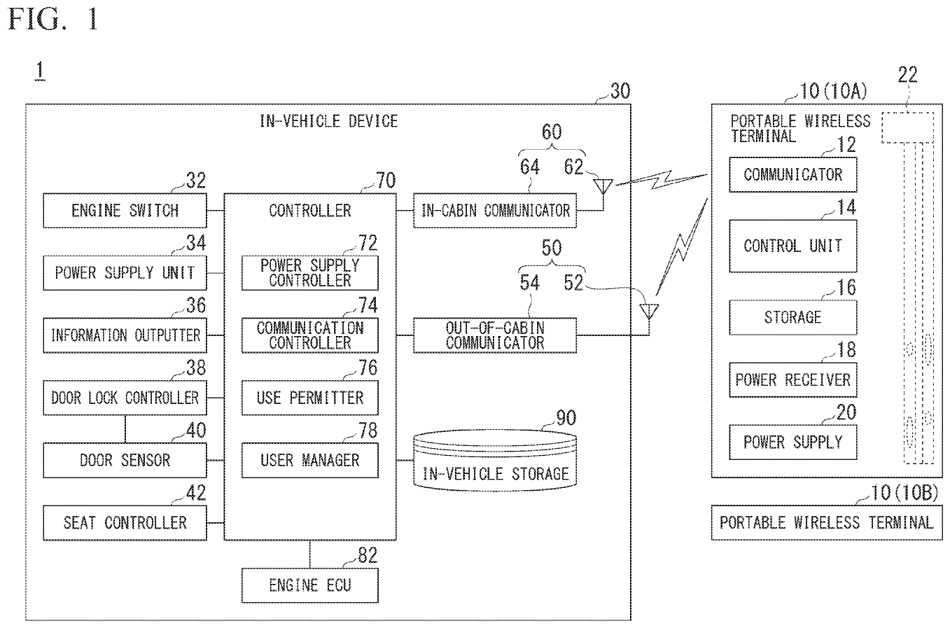

FIG. 1 is a diagram showing an example of a configuration of a vehicle control system 1 of an embodiment. The vehicle control system 1 includes a plurality of portable wireless terminals 10 and an in-vehicle device 30 mounted in a control target vehicle (hereinafter referred to as a “host vehicle”). The portable wireless terminal 10 is an example of an “electronic key” for a vehicle. The portable wireless terminal 10 and the in-vehicle device 30 can communicate with each other through wireless communication and the in-vehicle device 30 causes the host vehicle to perform a predetermined operation using communication with the portable wireless terminal 10 as a trigger. With such a mechanism, the user can use the portable wireless terminal 10 to cause the host vehicle to perform an operation such as unlocking a door lock or starting an engine. The vehicle control system 1 is an example of a “mobile object setting system” and the in-vehicle device 30 is an example of a “setting device.” The host vehicle is an example of a mobile object and a setting target in the mobile object setting system may be a mobile object other than a car, such as a watercraft or an aircraft.

Portable wireless terminals 10A and 10B are examples of a plurality of portable wireless terminals 10 and have similar functional configurations. Here, two portable wireless terminals 10 are exemplified in consideration of a main key and a spare key, but the number of portable wireless terminals 10 may be one or three or more. Hereinafter, unless otherwise distinguished, the portable wireless terminals 10A and 10B are collectively referred to as a portable wireless terminal 10. Hereinafter, when it is necessary to distinguish the portable wireless terminals 10A and 10B in the description with respect to a functional configuration similar to that described above, “A” or “B” may be added to the reference sign of each functional unit to distinguish them. For example, it is assumed that a “communicator 12A” is a communicator 12 of the portable wireless terminal 10A. The portable wireless terminal 10 is an example of a “terminal device.” The portable wireless terminal 10A is an example of a “first terminal device” and the portable wireless terminal 10B is an example of a “second terminal device.”

### [2. Configuration of Portable Wireless Terminal]

The portable wireless terminal 10 is, for example, a so-called FOB key (key fob), a thin card key, or the like. These portable wireless terminals 10, for example, have sizes in which they can be accommodated in a wallet. The portable wireless terminal 10, for example, has a size of about several centimeters (cm) to 10 cm in length, several centimeters (cm) to 10 cm in width, and several millimeters (mm) to several centimeters (cm) in thickness. In the following embodiment, an example in which the portable wireless terminal 10 is a FOB key will be described, but it may be another electronic key. The portable wireless terminal 10 may have the above-described function by installing an application program in a portable phone such as a smartphone, a tablet terminal, or the like.

In the portable wireless terminal 10, for example, a communicator 12, a control unit 14 including an integrated circuit and the like, a storage 16, a power receiver 18, a power supply 20, and a mechanical key 22 are housed in a housing (not shown). For example, the communicator 12 performs a predetermined process such as amplification or demodulation for received radio waves or generates radio waves to be transmitted. The storage 16 stores a terminal ID, which is identification information of the portable wireless terminal 10, in advance. The terminal ID is an example of “terminal information.”

The control unit 14 normally controls the portable wireless terminal 10 in a sleep state, which is a power-saving state. When a request signal is received from the in-vehicle device 30, the control unit 14 controls the portable wireless terminal 10 so that the portable wireless terminal 10 transitions from the sleep state to a startup state. The control unit 14 causes the communicator 12 to transmit a (out-of-cabin or in-cabin) response signal that is a response signal corresponding to the reception of a (out-of-cabin or in-cabin) request signal transmitted from the in-vehicle device 30.

The power supply 20 is, for example, a button battery. The portable wireless terminal 10 operates with electric power supplied from the power supply 20. When an amount of electric power stored in the power supply 20 (a residual power amount) is insufficient, the portable wireless terminal 10 does not operate. In this case, the user needs to replace, for example, the button battery. The power supply 20 may be, for example, a battery capable of being charged with electric power supplied through a Universal Serial Bus (USB).

The mechanical key 22 is a key for mechanically unlocking or locking a lock of a door (a door lock). When the user inserts the mechanical key 22 into a keyhole of the door of the host vehicle and performs a predetermined operation, the door lock of the host vehicle transitions to an unlocked or locked state.

### [3. Configuration of In-Vehicle Device]

The in-vehicle device 30 is mounted in the host vehicle. The in-vehicle device 30 can control each part of the host vehicle so that each part of the host vehicle can perform a predetermined operation. The predetermined operation is an operation for adjusting a driving environment of the host vehicle to a mode according to the user. In the present embodiment, the adjustment of the seat position will be described as an example of adjustment of the driving environment. The in-vehicle device 30 has a user account management function (user management function) and can switch an operating environment for each user account. The in-vehicle device 30 adjusts the seat position based on setting information of a designated user account when the user uses the host vehicle. For example, the user management function is implemented by an operating system. The automatic adjustment function for the seat position may be implemented as a function of the operating system or as a function of an application program operating on the operating system.

The host vehicle in which the in-vehicle device 30 is mounted is, for example, a vehicle such as a three- or four-wheeled vehicle, and includes a vehicle using an internal combustion engine such as a diesel engine or a gasoline engine as a motive power source, an electric vehicle using an electric motor as a motive power source, a hybrid vehicle having an internal combustion engine and an electric motor, or the like. The above-described electric vehicle is driven using electric power with which a battery such as, for example, a secondary battery, a hydrogen fuel cell, a metal fuel cell, or an alcohol fuel cell, is discharged.

The in-vehicle device 30 includes, for example, an engine switch 32, a power supply unit 34, an information outputter 36, a door lock controller 38, a door sensor 40, a seat controller 42, an out-of-cabin communication unit 50, an in-cabin communication unit 60, a controller 70, an engine ECU 82, and an in-vehicle storage 90.

The engine switch 32 is, for example, a switch provided at a position where a manipulation can be performed by a user of the host vehicle. The engine switch 32 is, for example, a mechanical switch. When the engine switch 32 is manipulated by the user, a manipulation signal indicating that a manipulation has been performed is output to the controller 70.

The power supply unit 34 is provided, for example, in the vicinity of the engine switch 32. When the engine switch 32 has been manipulated, the power supply unit 34 supplies electric power from the engine switch 32 to a portable wireless terminal 10 located within a predetermined range based on control of the controller 70. For example, the power supply unit 34 and the power receiver 18 of the portable wireless terminal 10 transmit and receive electric power using the principle of electromagnetic induction.

The information outputter 36 outputs predetermined information in accordance with an instruction of the controller 70. The information outputter 36 is a display that displays indicators and information as images. The display is, for example, a display of an instrument panel that displays a state (speed or the like) of the host vehicle. The display may be, for example, a liquid crystal display (LCD), an organic electroluminescence (EL) display device, or the like. The display may be a head-up display that reflects an image on a window of the host vehicle, a display provided in a navigation device, or the like. The information outputter 36 may be a speaker that outputs a sound.

The door lock controller 38 and the seat controller 42 are implemented by executing a program in a processor such as, for example, a central processing unit (CPU). The door lock controller 38 is connected to a door lock actuator (not shown), the door sensor 40, and the controller 70. For example, when an instruction signal for the locking or unlocking of the door lock of the host vehicle has been received from the controller 70, the door lock controller 38 controls the door lock actuator so that the door lock actuator executes the locking or unlocking of the door lock. The door lock actuator controls the door lock so that the door lock is in an open or closed state by driving a door lock mechanism provided in the host vehicle. The door lock controller 38 may be a part of the controller 70.

The door sensor 40 is, for example, a capacitance change type touch sensor in which the capacitance changes when the user touches a door handle. The door sensor 40 is in an OFF state normally. When the user touches the door handle and the capacitance changes to a predetermined value or more, the door sensor 40 outputs an instruction signal for unlocking the door lock in an ON state to the controller 70 via the door lock controller 38.

The seat controller 42 is connected to the seat drive actuator (not shown) and the controller 70. For example, when an instruction signal for a change in the position of the seat in the host vehicle has been received from the controller 70, the seat controller 42 controls the seat drive actuator so that the seat drive actuator moves the seat back and forth. A control target of the seat controller 42 is typically a driver's seat and/or a passenger seat, but other seats may also be controlled if other seats can be electrically controlled. The seat drive actuator moves the seat to a designated position by driving a sliding mechanism provided in the host vehicle to move the seat back and forth. When the seat is an electrically controllable reclining seat, the seat controller 42 may be configured to control a tilt of the seat in addition to the seat position. The seat controller 42 may be a part of the controller 70.

The out-of-cabin communication unit 50 includes an out-of-cabin antenna 52 and an out-of-cabin communicator 54 electrically connected to the out-of-cabin antenna 52. The out-of-cabin antenna 52 is provided, for example, on a door mirror on the driver's seat side of the host vehicle, the door handle, or the like. The out-of-cabin communicator 54 is provided, for example, below the surface of an instrument panel. In accordance with the reception of an instruction signal for unlocking the door lock or an instruction signal for locking the door lock from the controller 70, the out-of-cabin communication unit 50 transmits an out-of-cabin request signal for requesting the transmission of a terminal ID to the portable wireless terminal 10 outside of the cabin. The out-of-cabin antenna 52 receives an out-of-cabin response signal transmitted from the portable wireless terminal 10. The out-of-cabin communicator 54 acquires an out-of-cabin response signal received by the out-of-cabin antenna 52, performs amplification, decoding, or other processing on the acquired out-of-cabin response signal, and outputs information included in the out-of-cabin response signal to the controller 70.

The in-cabin communication unit 60 is provided, for example, under the surface of the instrument panel. The in-cabin communication unit 60 includes an in-cabin antenna 62 and an in-cabin communicator 64 electrically connected to the in-cabin antenna 62. The in-cabin antenna 62 transmits an in-cabin request signal to the portable wireless terminal 10 in the cabin. The in-cabin antenna 62 receives an in-cabin response signal from the portable wireless terminal 10 in the cabin. The in-cabin communicator 64 acquires the in-cabin response signal received by the in-cabin antenna 62, performs amplification, decoding, or other processing on the acquired in-cabin signal, and outputs information included in the in-cabin response signal to the controller 70.

The controller 70 includes, for example, a power supply controller 72, a communication controller 74, a use permitter 76, and a user manager 78. The power supply controller 72, the communication controller 74, the use permitter 76, and the user manager 78 are implemented by a hardware processor such as a CPU executing the program (software). The program may be implemented, for example, as a vehicle operating system having a control function of the host vehicle, or may be implemented as an application program operating on the vehicle operating system. Also, some or all of these components may be implemented by hardware (including a circuit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The in-vehicle storage 90 is implemented by, for example, a non-volatile storage device such as a read-only memory (ROM), an electrically erasable and programmable read-only memory (EEPROM), or a hard disk drive (HDD) and a volatile storage device such as a random-access memory (RAM) or a register.

The power supply controller 72 controls the power supply unit 34 so that the power supply unit 34 supplies electric power to the portable wireless terminal 10 and enables the portable wireless terminal 10 to transmit the terminal ID to the host vehicle using the supplied electric power.

The communication controller 74 controls the out-of-cabin communication unit 50 or the in-cabin communication unit 60 so that the out-of-cabin communication unit 50 or the in-cabin communication unit 60 communicates with the portable wireless terminal 10. When the power supply unit 34 supplies electric power to the portable wireless terminal 10 according to electromagnetic induction, in a case where the use permitter 76 permits the start of the host vehicle, the communication controller 74 causes the in-cabin communication unit 60 to transmit an in-cabin request signal to the cabin and detects an in-cabin response signal, which is a response of the portable wireless terminal 10 to the transmitted in-cabin request signal.

The use permitter 76 decides to permit or disallow the use of the host vehicle by the user. Permitting the use of the host vehicle here is, for example, permitting the unlocking of the door lock of the host vehicle, permitting the start of the host vehicle, or the like. For example, the use permitter 76 compares the terminal ID received from the portable wireless terminal 10 using the out-of-cabin communication unit 50 with the terminal ID registered in the in-vehicle storage 90 in advance and permits the unlocking of the door lock of the host vehicle based on a comparison result. For example, the use permitter 76 permits the unlocking of the door lock of the vehicle when the received terminal ID is identical to the terminal ID registered in the in-vehicle storage 90 in advance. This terminal ID is included in the out-of-cabin response signal.

For example, the use permitter 76 compares the terminal ID received from the portable wireless terminal 10 using the in-cabin communication unit 60 with the terminal ID registered in the in-vehicle storage 90 in advance and permits the start of the vehicle based on a comparison result. The use permitter 76 permits the start of the vehicle when the received terminal ID is identical to the terminal ID registered in the in-vehicle storage 90 in advance. This terminal ID is included in the in-cabin response signal. The in-cabin response signal includes information indicating the remaining amount of electric power of the power supply 20. Permitting the start of the vehicle is permitting control so that the vehicle is in any state such as a state in which the engine is started, a state in which a motor is started, or a state in which a lock of a steering wheel is unlocked.

The user manager 78 manages a user account registered in the in-vehicle device 30 for the user of the host vehicle. Setting information for automatic adjustment of the seat position (hereinafter referred to as “seat position setting information”) is associated with the user account. The user account does not necessarily have to correspond one-to-one with the user. For example, the user may create a plurality of user accounts with different setting content for the seat position setting information and separately use the user accounts in accordance with a use state, a purpose, and the like. For simplicity below, it is assumed that one user account is registered for each user in the in-vehicle device 30. User account management information (hereinafter referred to as “account management information”), for example, is stored in the in-vehicle storage 90.

The user manager 78 automatically adjusts the seat position in accordance with a user account (hereinafter referred to as a “target account”) designated as a setting target. More specifically, the user manager 78 acquires the seat position setting information of the target user account with reference to the account management information and automatically adjusts the seat position based on the acquired seat position setting information. The target account may be designated when the user performs a manipulation of selecting the user account to be used as the target account from the user accounts registered in the in-vehicle device 30. When the terminal ID is transmitted from the portable wireless terminal 10, the target account may be mechanically decided on by associating it with the portable wireless terminal 10. The user manager 78 is an example of an “identifier” and a “setter.”

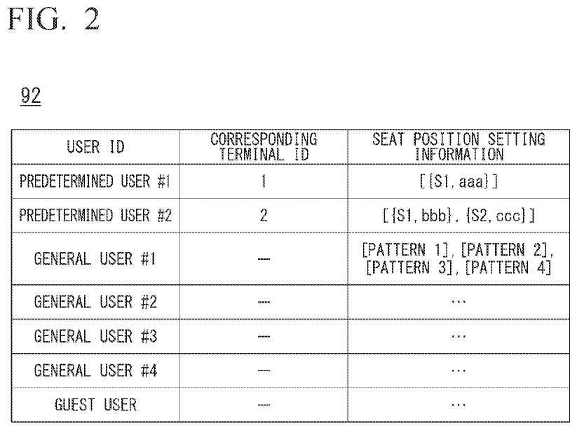

FIG. 2 is a diagram showing a specific example of account management information. The account management information 92 is managed, for example, as a table in which a corresponding terminal ID and seat position setting information are associated with a user ID. The user ID is user account identification information. The corresponding terminal ID indicates the association between the user account and the portable wireless terminal 10 and the identification information (terminal ID) of the portable wireless terminal 10 associated with the corresponding user account is stored. The example of FIG. 2 indicates a case where the portable wireless terminal 10A (here, terminal ID “1”) is associated with “predetermined user #1” and the portable wireless terminal 10B (here, terminal ID “2”) is associated with “predetermined user #2.” “Predetermined user #1” is an example of a “first user ID” and “predetermined user #2” is an example of a “second user ID.”

The seat position setting information is expressed, for example, by a set of identification information of a control target seat and information of a target seat position (for example, an amount of displacement from a reference position). In the example of FIG. 2, the seat position setting information of “predetermined user #1” indicates that a seat identified by “S1” is controlled so that the seat is at the seat position “aaa.” In the example of FIG. 2, the seat position setting information of “predetermined user #2” indicates that a seat identified by “S1” is controlled so that the seat is at a seat position “bbb” and a seat identified by “S2” is controlled so that the seat is at a seat position “ccc.” Thus, the seat position setting information may include setting information for a plurality of seats.

In the example of FIG. 2, the seat position setting information of “general user #1” indicates a case where a plurality of setting patterns (here, patterns 1 to 4) are registered. The above-described seat position setting information of “predetermined user #1” and “predetermined user #2” is all examples of cases where one setting pattern is registered. One of the plurality of setting patterns to be adopted may be decided on by a default value or may be decided on by the user's selection manipulation. A plurality of setting patterns may be changed by the user's switching manipulation or a previously used setting pattern may be automatically handed over.

In the example of FIG. 2, “predetermined user #1” and “predetermined user #2” are predetermined user accounts registered in advance in the in-vehicle device 30 of the initial state and are user accounts associated with the portable wireless terminal 10 of the user. Here, two predetermined user accounts are created in consideration of two portable wireless terminals 10A and 10B. For example, the predetermined user account is registered in the in-vehicle device 30 by a manufacturer of the host vehicle, a manufacturer of the in-vehicle device, a car dealer that sells the host vehicle or the in-vehicle device, or the like. The seat position setting information set in the predetermined user account may be uniformly decided on by a registrant (for example, a manufacturer or a car dealer) or may be decided on by the registrant to reflect the user's request.

For example, when there is one user of the host vehicle, only a predetermined user account associated with a plurality of portable wireless terminals 10 may be registered in the in-vehicle device 30 of the initial state. In this case, when the user uses the host vehicle with one of the portable wireless terminals 10, a user account associated with the used portable wireless terminal 10 is selected and the seat position is automatically adjusted according to the seat position setting information associated with the user account. Thus, when there is one user of the host vehicle, the in-vehicle device 30 in a state in which a predetermined user account associated with the portable wireless terminal 10 is registered in advance is provided to the user. Thereby, the user can use the automatic adjustment function for the seat position when the host vehicle is used even though a registration task or a setting task for the user account is not performed with respect to the in-vehicle device 30.

On the other hand, for example, when there are a plurality of users of the host vehicle, user accounts corresponding to a plurality of users may be registered in the in-vehicle device 30 of the initial state in addition to a predetermined user account. In this case, at least one of the plurality of portable wireless terminals 10 is associated with a predetermined user account, and the other portable wireless terminal 10 is associated with an account other than the predetermined user account. In this case, a predetermined user (for example, an owner of the host vehicle) among the plurality of users uses the host vehicle with the portable wireless terminal 10 associated with the predetermined user account, such that a user account associated with the used portable wireless terminal 10 is selected and the seat position is automatically adjusted according to the seat position setting information associated with the user account. In this case, a user other than the predetermined user among the plurality of users uses the host vehicle with a portable wireless terminal 10 that is not associated with the predetermined user account, such that a user account associated with the used portable wireless terminal 10 (a user account other than the predetermined user account) is selected and the seat position is automatically adjusted according to the seat position setting information associated with the user account. Thus, when there are a plurality of users of the host vehicle, the in-vehicle device 30 is provided to the users in a state in which the plurality of portable wireless terminals 10 are associated with the user accounts of different users, such that the plurality of portable wireless terminals 10 can be separately used by a plurality of users and the plurality of users can use an automatic adjustment function for the seat position using the seat position setting information.

### [4. Process at Time of Boarding and Starting]

[4.1. Process at Time of Boarding; when Door Lock is Unlocked Through Communication]

When the user boards the host vehicle, the following process is performed. For example, when a predetermined condition is satisfied (for example, when the controller 70 acquires an instruction signal for unlocking the door lock), the communication controller 74 of the controller 70 causes the out-of-cabin communication unit 50 to transmit an out-of-cabin request signal.

When the out-of-cabin request signal is received, the portable wireless terminal 10 transmits an out-of-cabin response signal, which is a response to the out-of-cabin request signal, to the out-of-cabin communication unit 50.

The user manager 78 of the controller 70 determines whether or not the user ID included in the out-of-cabin response signal received by the out-of-cabin communication unit 50 is identical to the user ID stored in the in-vehicle storage 90. When the user IDs are identical, the user manager 78 causes the door lock controller 38 to unlock the door lock of the host vehicle. Thereby, the user can board the host vehicle.

### [4.2. Process at the Time of Starting; Process at Normal Time]

For example, as described above, when the door lock is unlocked through communication and an engine start manipulation is performed, the communication controller 74 causes the in-cabin communication unit 60 to transmit an in-cabin request signal. The engine start manipulation is, for example, a manipulation in which the engine switch 32 is pressed in a state in which a brake pedal is depressed. When the portable wireless terminal 10 receives an in-cabin request signal, the portable wireless terminal 10 transmits an in-cabin response signal, which is a response to the in-cabin request signal, to the in-cabin communication unit 60.

The user manager 78 of the controller 70 determines whether or not a user ID included in the in-cabin response signal received by the in-cabin communication unit 60 is identical to the user ID stored in the in-vehicle storage 90. When the user IDs are identical, the user manager 78 causes the engine ECU 82 to operate the engine. Thereby, the user can start the engine of the host vehicle.

### [5. Automatic Adjustment Function for Seat Position]

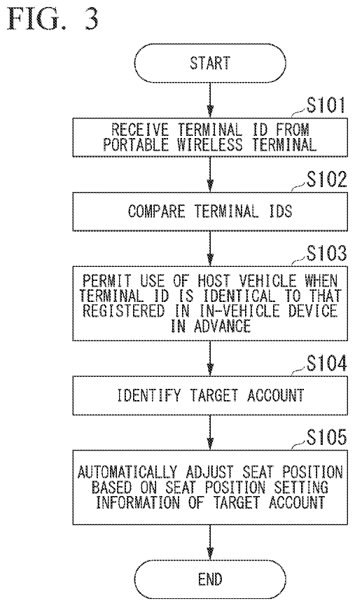

FIG. 3 is a flowchart showing an example of a flow of a process in which the in-vehicle device 30 automatically adjusts the seat position when the user uses the host vehicle. First, the in-vehicle device 30 receives a terminal ID from the portable wireless terminal 10 (S101). Subsequently, the in-vehicle device 30 compares the received terminal ID with a terminal ID registered in the in-vehicle storage 90 in advance (S102) and permits the use of the host vehicle (the unlocking of the door lock or the transmission of the host vehicle) when the two are identical (S103). Subsequently, the in-vehicle device 30 identifies a target account with reference to the account management information 92 based on the received terminal ID (S104). Subsequently, the in-vehicle device 30 automatically adjusts a seat position based on seat position setting information of the identified target account (S105).

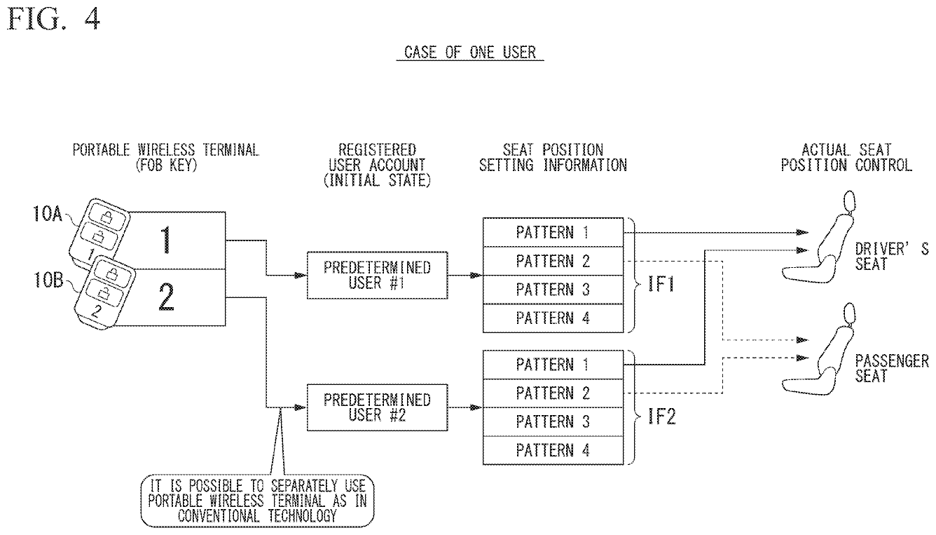

FIG. 4 is a diagram showing an example of an operation when the in-vehicle device 30 automatically adjusts the seat position when there is one user of the host vehicle. As described above, the in-vehicle device 30 is provided to the user in a state (initial state) in which at least a predetermined user account associated with the portable wireless terminal 10 is registered. The example of FIG. 4 shows a state in which the portable wireless terminal 10A (terminal ID “1”) is associated with “predetermined user #1,” and the portable wireless terminal 10B (terminal ID “2”) is associated with “predetermined user #2” when only “predetermined user #1” and “predetermined user #2” are registered as user accounts. The example of FIG. 4 shows a case where four setting patterns are registered in the seat position setting information of “predetermined user #1” and “predetermined user #2.” In this case, one user can separately use different seat position setting information for the same seat by separately using the portable wireless terminals 10A and 10B, i.e., by separately using “predetermined user #1” and “predetermined user #2.”

In this example, pattern 1 indicates the setting content of the driver's seat position and pattern 2 indicates the setting content of the seat position of the passenger seat. In this example, pattern 3 may indicate a seat position corresponding to a so-called seat memory function. The seat memory function is a function of saving the seat position according to a manual manipulation of the user or automatically and restoring the saved seat position as necessary. When the seat memory function is provided, the in-vehicle device 30 may register the saved seat position in the seat position setting information of the target account. In this example, pattern 4 may indicate a seat position corresponding to the so-called easy entry function. The easy entry function is a function of controlling an in-vehicle environment (including a seat position) in a state in which the user can easily board the vehicle when the user is boarding. When the in-vehicle device 30 has an easy entry function, the seat position to be implemented in the function may be registered in the seat position information of the predetermined user account.

FIG. 4 shows a case where pattern 1 is selected as a default value among the four setting patterns. In this case, when the user has the portable wireless terminal 10A, pattern 1 of seat position setting information IF1 of “predetermined user #1” is applied to automatic adjustment of the seat position. Likewise, when the user has the portable wireless terminal 10B, pattern 1 of seat position setting information IF2 of “predetermined user #2” is applied to automatic adjustment of the seat position.

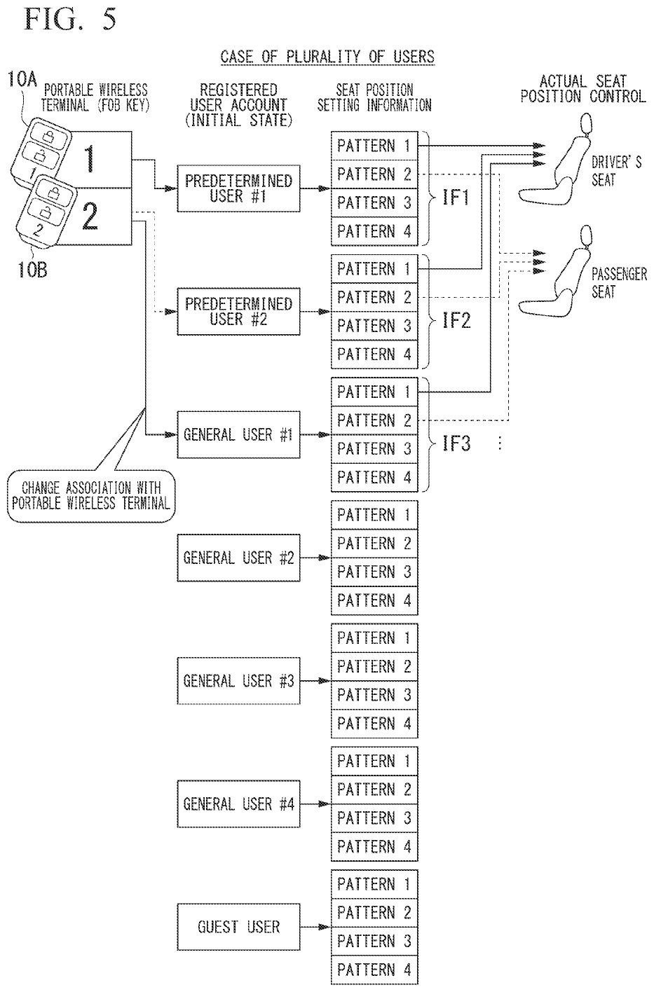

On the other hand, FIG. 5 is a diagram showing an example of an operation when the in-vehicle device 30 automatically adjusts the seat position when there are a plurality of users of the host vehicle. The example of FIG. 5 shows a case where “predetermined user #1,” “predetermined user #2,” “general user #1,” “general user #2,” “general user #3,” “general user #4,” and “guest user” are registered in the in-vehicle device 30 of the initial state. In the example of FIG. 4, both the portable wireless terminals 10A and 10B are associated with “predetermined user #1” and “predetermined user #2.” On the other hand, in the example of FIG. 5, the portable wireless terminal 10A is associated with “predetermined user #1” and the portable wireless terminal 10B is associated with “general user #1.” In this case, the predetermined user (for example, the owner of the host vehicle) can use the portable wireless terminal 10A by himself or herself and allow another user to use the portable wireless terminal 10B.

In this case, when the predetermined user uses the portable wireless terminal 10A, pattern 1 of the seat position setting information IF1 of “predetermined user #1” is applied to automatic adjustment of the seat position. On the other hand, when another user uses the portable wireless terminal 10B, pattern 1 of the seat position setting information IF3 of “general user #1” is applied to automatic adjustment of the seat position.

Thus, when there are a plurality of users of the host vehicle, the in-vehicle device 30 is provided to the users in a state in which the plurality of portable wireless terminals 10 are associated with different user accounts, such that the plurality of portable wireless terminals 10 can be separately used by a plurality of users and the plurality of users can use an automatic adjustment function for the seat position using the seat position setting information.

When there are a plurality of users of the host vehicle, a configuration of the in-vehicle device 30 may be implemented according to a predetermined manipulation of the user on the in-vehicle device 30. For example, when a change from the configuration of FIG. 4 to the configuration of FIG. 5 is made, it is only necessary for the predetermined user to perform the following tasks.
(1) Create “general user #1,” “general user #2,” “general user #3,” “general user #4,” and “guest user.”
(2) Register the seat position setting information in each user account. When a task of setting the seat position is entrusted to the user, this task may be omitted.
(3) Change the association of a corresponding terminal ID. Specifically, the association with the portable wireless terminal 10B (terminal ID “2”) is changed from “predetermined user #2” to “general user #1.”

A change in the association between the portable wireless terminal 10 and the user account can also be implemented by changing the terminal ID stored by the portable wireless terminal 10 instead of the method of changing the account management information 92 in the above-described (3). For example, the association between the user ID and the seat position setting information is managed in the account management information 92 and the portable wireless terminal 10 stores the user ID of any one of the registered user accounts instead of the terminal ID. Because the portable wireless terminal 10 can be associated with any user account in such a method, the automatic adjustment function for the seat position can be operated as described above. In this case, the in-vehicle device 30 may be configured to receive a manipulation of selecting a user account of a change destination when the host vehicle is manipulated using the portable wireless terminal 10 (for example, a door unlock manipulation or the like) and change the association with the portable wireless terminal 10 to the selected user account. In this case, the in-vehicle device 30 may be configured to receive the manipulation of selecting the user account of the change destination until a predetermined time period elapses from the time when the host vehicle is manipulated using the portable wireless terminal 10.

According to the vehicle control system 1 of the above-described embodiment, the manipulability related to the automatic adjustment can be improved in relation to the vehicle control system 1 that automatically adjusts the driving environment of the host vehicle in conjunction with the in-vehicle device 30 having a user management function.

As described above, the in-vehicle device 30 of the embodiment has a user management function and can manage automatic adjustment of the driving environment for each user account. However, in vehicles equipped with conventional in-vehicle devices that do not have such functions, the automatic adjustment of the driving environment has been managed by associating it with a portable wireless terminal, but there are not a few who prefer the conventional manipulation feeling and manipulability for automatic adjustment of the driving environment among the users of such conventional vehicles. On the other hand, as information equipment is becoming more sophisticated, it is assumed that in-vehicle devices can generally have a user management function like the in-vehicle device 30 of the embodiment and manage various types of settings related to the vehicle for each user account in the future. According to the in-vehicle device 30 of the embodiment, the advancement of the in-vehicle device can be implemented and the automatic adjustment of the driving environment can implement the manipulation feeling and manipulability similar to those in the conventional method.

Although the case where the user manager 78 adjusts the seat position as an example of the driving environment has been described in the above-described embodiment, the driving environment of an adjustment target is not limited thereto. For example, the user manager 78 may be configured to control an angle of a fender mirror, an inclination of the seat, a position and angle of the steering wheel, and the like. Even in such a case, the implementation is possible in a method similar to the automatic adjustment of the seat position by managing control setting information in association with a user account.

Although the case where the permission to use the host vehicle in the use permitter 76 is executed independently of the user management function has been described in the above-described embodiment, the use permitter 76 may be configured to permit the use of the host vehicle in cooperation with the user management function. For example, a terminal ID registered in the in-vehicle storage 90 may be managed according to the account management information 92. In this case, the use permitter 76 may be configured to recognize a target account and a corresponding terminal ID by performing a comparison process with the terminal ID with reference to the account management information 92. In this case, the use permitter 76 may be configured to perform an automatic adjustment process for the driving environment following the permission to use the host vehicle.

The user manager 78 of the in-vehicle device 30 may perform a login process for the user account. For example, the user manager 78 may be configured to manage a password for each user ID and transition to a login state when a user ID and a password input by the user are identical to those managed in the in-vehicle device 30. In this case, the automatic adjustment of the driving environment may be performed as a part of the process of transitioning to the login state.

The user manager 78 may be configured to switch a setting pattern of the seat position setting information in accordance with a manipulation on an input device such as a switch or a button. For example, such an input device may be implemented as a door switch. For example, a number of door switches corresponding to each setting pattern may be provided and a setting pattern associated with the manipulated door switch may be selected. The user manager 78 may automatically adjust the driving environment in accordance with this selection. The user manager 78 may be configured to provide one door switch instead of providing a plurality of door switches, switch the setting pattern every time there is a manipulation, or recognize a setting pattern to be selected in a manipulation mode (for example, the number of button manipulations, a button press length, or the like).

Although modes for carrying out the present invention have been described above using embodiments, the present invention is not limited to the embodiments and various modifications and substitutions can also be made without departing from the scope and spirit of the present invention.

What is claimed is:

1. A mobile object setting system including a setting device configured to perform a process of setting equipment provided in a mobile object and a plurality of terminal devices capable of communicating with the setting device,
wherein the setting device includes a storage device configured to store a program and setting information of the equipment and a hardware processor,
wherein the hardware processor
manages the setting information in association with a user of the mobile object by executing the program stored in the storage device,
identifies the user of the mobile object based on a result of communicating with the plurality of terminal devices, and
acquires the setting information of the equipment associated with the identified user from the storage device to perform the process of setting the equipment based on the acquired setting information,
wherein the plurality of terminal devices instruct the setting device to change the setting of the equipment by transmitting the terminal information stored therein to the setting device, and
wherein the storage device can store a plurality of setting information items for each piece of the equipment when the number of users registered in the setting device is one.

2. The mobile object setting system according to claim 1,
wherein the plurality of terminal devices include a first terminal device and a second terminal device, and
wherein, when the number of users registered in the setting device is one and first setting information and second setting information are stored as the setting information of the equipment in the storage device,
the hardware processor manages the first setting information in association with the first terminal device and manages the second setting information in association with the second terminal device.

3. The mobile object setting system according to claim 2,
wherein a first user ID and a second user ID are registered for one user in the setting device, and
wherein the first user ID is associated with the first terminal device and the second user ID is associated with the second terminal device.

4. The mobile object setting system according to claim 1,
wherein the plurality of terminal devices include a first terminal device and a second terminal device,
wherein a first user and a second user are registered in the setting device, and
wherein, when first setting information and second setting information are stored as the setting information of the equipment in the storage device,
the hardware processor manages the first setting information in association with the first terminal device and manages the second setting information in association with the second terminal device.

5. The mobile object setting system according to claim 4,
wherein a third user is further registered in the setting device, and
wherein, when the third user is selected in the setting device after the setting device acquires the first terminal information from the first terminal device or the second terminal device,
the terminal device, which has transmitted the first terminal information to the setting device, replaces the first terminal information stored in the terminal device with second terminal information stored in association with the third user in the setting device.

6. A mobile object setting method for use in a mobile object setting system including a setting device configured to perform a process of setting equipment provided in a mobile object and a plurality of terminal devices capable of communicating with the setting device, the mobile object setting method comprising:
managing, by the setting device, setting information of the equipment in association with a user of the mobile object;
identifying, by the setting device, the user of the mobile object based on a result of communicating with the plurality of terminal devices;
performing, by the setting device, a process of setting the equipment based on the setting information of the equipment associated with the identified user; and
instructing, by the plurality of terminal devices, the setting device to change the setting of the equipment by transmitting the terminal information stored therein to the setting device,
wherein, when the number of users registered in the setting device is one, the setting device can store a plurality of setting information items for each piece of the equipment.

7. A storage medium storing a program for use in a mobile object setting system including a setting device configured to perform a process of setting equipment provided in a mobile object and a plurality of terminal devices capable of communicating with the setting device and configured to instruct the setting device to change the setting of the equipment by transmitting the terminal information stored therein to the setting device,
wherein the program causes the setting device to:
manage setting information of the equipment in association with a user of the mobile object,
identify the user of the mobile object based on a result of communicating with the plurality of terminal devices,
perform a process of setting the equipment based on the setting information of the equipment associated with the identified user, and
manage a plurality of setting information items for each piece of the equipment when the number of users registered in the setting device is one.
